(19) United States
(12) Patent Application Publication
(10) Pub. No.: US 2019/0050823 A1
(43) Pub. Date: Feb. 14, 2019

(54) DISTRIBUTED VARIABLE COMPONENT REPAIR MANAGEMENT SYSTEM

(71) Applicant: Sarah Evans, Austin, TX (US)

(72) Inventor: Sarah Evans, Austin, TX (US)

(21) Appl. No.: 16/058,179

(22) Filed: Aug. 8, 2018

Related U.S. Application Data
(60) Provisional application No. 62/542,797, filed on Aug. 8, 2017.

(51) Int. Cl. G06Q 10/00; G06F 17/30

(52) U.S. Cl. CPC G06Q 10/20; G06F 17/30327

(57) ABSTRACT

Systems and methods disclosed herein comprise a distributed computing network to receive information identifying a technology, receive, via a communications network, a query for required repairs and compute a location-based solution based on technology and resources available. Embodiments of the invention may include systems and methods to assess technology-based problems and compute a solution based on an assessment of a communication display mechanism of a user device, elements needed for repairs, location-based information based on the user device, the technology, and repair elements, and compute a decision tree to a user device in order to implement a solution.

### CROSS REFERENCE TO RELATED APPLICATIONS

This application claims priority to U.S. Provisional Patent Application Ser. No. 62/542,797, filed Aug. 8, 2017, entitled “DISTRIBUTED VARIABLE COMPONENT REPAIR MANAGEMENT SYSTEM” the entire content of which is incorporated herein by reference.

### FIELDS OF THE INVENTION

The disclosure as detailed herein is in the technical field of distributed computing technology. More specifically it is in the field of computational decision tree analysis.

### DESCRIPTION OF RELATED ART

There are many organizations that provide people with technologies in third world countries. These include NGOs, charity groups, and religious organizations. Some of the technologies include sewer systems, refrigeration systems, mobile systems, electricity, and other basic technological first world needs. Often, these technologies are at different stages of development, have been installed over a lengthy period of time, and are in variable states of both disrepair and/or technological development. Considering the lack of resources in these areas, when one of these technologies breaks down, there is limited means to repair the system. Therefore, there is a need for a distributed repair network that can analyze the repair area, technology, parts available, and communication systems to adequately give information as to repair the technology when broken.

### GENERAL SUMMARY OF THE INVENTION

Systems and methods disclosed herein comprise a distributed computing network that allows someone to identify a technology in a third world country, use an existing communications network to query for the repairs that are needed based on the technology and the resources available. Embodiments of the invention include parameters to assess the problems with the technology, assess the communication display mechanism such as what type of phone to send/receive instructions, assess the needed repair parts, assess the location of the technology that needs to be replaced and the location of the parts that will be used for replacement, and the ability to display the repair instructions in a decision tree program.

This invention allows one to very quickly determine the age of technology, type of technology, repairs needed, repairs to be located, and send back instructions based on the type of medium that is required to display the instructions. It considers, at least, these parameters before sending instructions to a computing device. Then, employs a decision tree process to describe a proposed repair.

### DESCRIPTION OF FIGURES

FIG. 1 is a perspective view, which shows an exemplary hardware architecture of a computing device used in an embodiment of the invention.

FIG. 2 is a perspective view, which shows a diagram view of an exemplary logical architecture for a client device according to an embodiment of the invention.

FIG. 3 is a perspective view, which shows diagram of an exemplary architectural arrangement of clients, servers, and external services according to an embodiment of the invention.

FIG. 4 is a perspective view, which shows a diagram view of an embodiment of a hardware architecture of a computing device used in various embodiments of the invention.

FIG. 5 is a perspective view, which shows a system diagram of the repair management system.

FIG. 6 is a perspective view, which shows a diagram of technology expert devices and input interfaces.

FIG. 7 is a perspective view, which shows a diagram of the organization of a repair case manager device and interfaces.

FIG. 8 is a perspective view, which shows a diagram of an interaction between on-site manager devices, repair case member devices, and persons.

FIG. 9 is a perspective view, which shows a diagram of the data organization of repair management data.

FIG. 10 is a diagram of the overall use of the system.

FIG. 11 is a diagram of creating a technology repair situation application.

FIG. 12 is a diagram of entering data into the situation creator module.

FIG. 13 is a diagram of sending data to a repair case manager.

FIG. 14 is a diagram of navigating the repair case manager interface.

### DETAILED DESCRIPTION

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

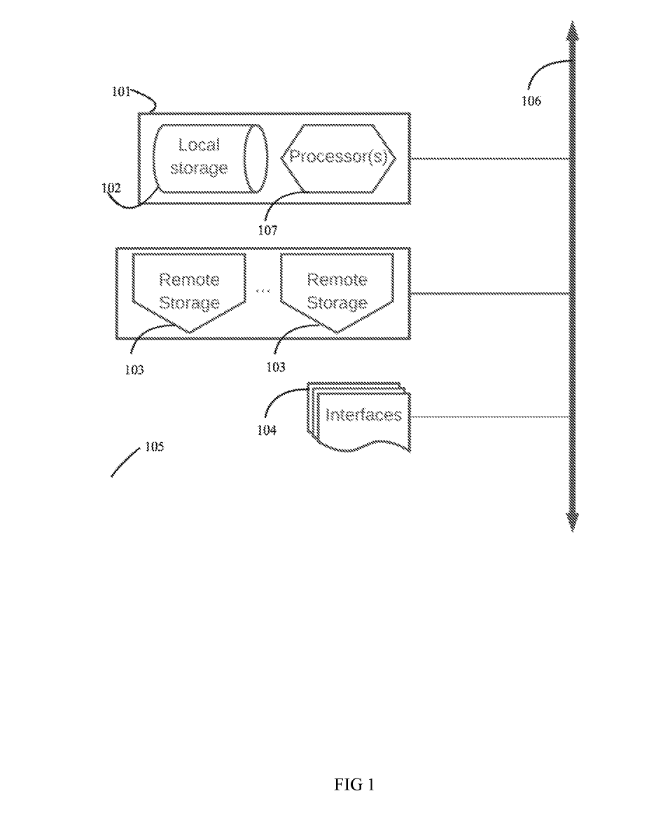

Referring now to FIG. 1, which shows an exemplary hardware architecture of a computing device used in an embodiment of the invention.

The central processing unit is an acronym which stands for CPU 101. In some embodiments, examples of CPU 101 may include: a system-on-a-chip (SOC) type hardware, a Qualcomm SNAPDRAGON™, or a Samsung™ EXYNOS™ CPU. The CPU 101 comprises a unit responsible for implementing specific functions associated with the functions of a specifically configured computing device or machine. The local memory 102 comprises one or more physical devices used to store programs (sequences of instructions) or data (e g. program state information) on a temporary or permanent basis for use in a computer or other digital electronic device, which may be configured to couple to the system in many different configurations. In some embodiments, examples of local memory 102 may include: a non-volatile random-access memory (RAM), a read-only memory (ROM), or one or more levels of cached memory. The local memory 102 functions to both 1) cache and/or store data and to 2) store programming instructions. The remote memory 103 comprises a service that provides users with a system for the backup, storage, and recovery of data. In some embodiments, examples of an interface 104 may include: network interface cards (NICs), ethernet interfaces, frame relay interfaces, cable interfaces, DSL interfaces, token ring interfaces, graphics interfaces, universal serial bus (USB) interfaces, Serial port interfaces, Ethernet interfaces, FIREWIRE™ interfaces, THUNDERBOLT™ interfaces, PCI interfaces, parallel interfaces, radio frequency (RF) interfaces, BLUETOOTH interfaces, near-field communications interfaces, 802.11 (WiFi) interfaces, frame relay interfaces, TCP/IP interfaces, ISDN interfaces, fast Ethernet interfaces, Gigabit Ethernet interfaces, Serial ATA (SATA) or external SATA (ESATA) interfaces, a high-definition multimedia interface (HDMI), a digital visual interface (DVI), analog or digital audio interfaces, asynchronous transfer mode (ATM) interfaces, high-speed serial interface (HSSI) interfaces, Point of Sale (POS) interfaces, or fiber data distributed interfaces (FDDIs).

The interface 104 comprises a mechanism to control the sending and receiving of data packets over a computer network or support peripherals used with the computing device 105.

In some embodiments, examples of computing device 105 may include: desktop computers, carputers, game consoles, laptops, a notebook, a palmtop, a tablet, smartphones, smart books, or a server system utilizing CPU 101, local memory 102 and/or remote memory 103, and interface 104. The computing device 105 comprises an electronic device capable of executing software- or hardware-based instructions according to one or more programs stored in memory.

In some embodiments, examples of communications network 106 may include: a personal area network, a wireless personal area network, a near-me area network, a local area network, a wireless local area network, a wireless mesh network, a wireless metropolitan area network, a wireless wide area network, a cellular network, a home area network, a storage area network, a campus area network, a backbone area network, a metropolitan area network, a wide area network, an enterprise private network, a virtual private network, an intranet, an extranet, an Internetwork, an Internet, a near field communications, a mobile telephone network, a CDMA network, a GSM cellular networks, or a WiFi network. The communications network 106 comprises a communications network that allows computers to exchange data using known protocols.

In some embodiments, examples of processor 107 may include: an Intel™ processor, an ARM™ processor, a Qualcomm™ processor, an AMD™ processor, application-specific integrated circuits (ASICs), electrically erasable programmable read-only memories (EEPROMs), field-programmable gate arrays (FPGAs), a mobile processor, a microprocessor, a microcontroller, a microcomputer, a programmable logic controller, or a programmable circuit.

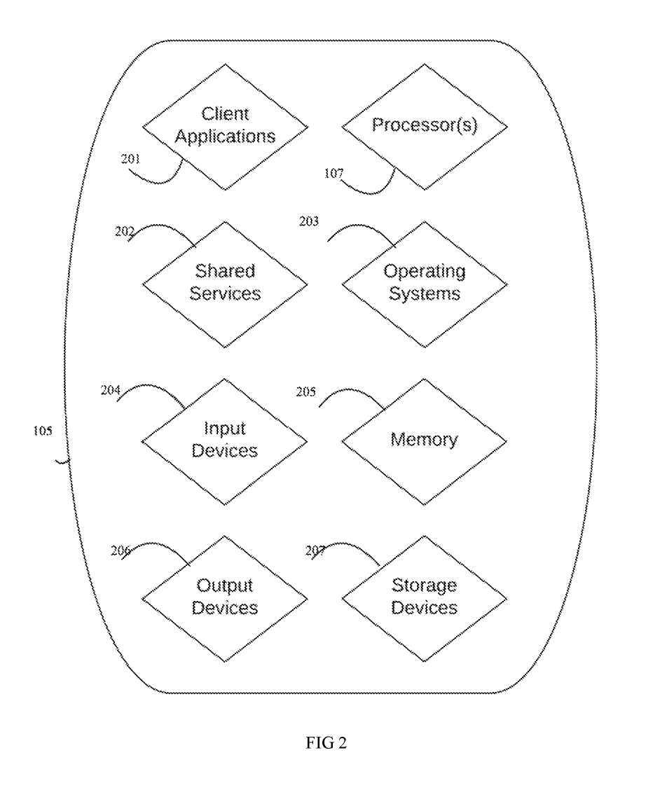

Referring now to FIG. 2, which shows a diagram view of an exemplary logical architecture for a client device according to an embodiment of the invention.

The shared service 202 comprises web-enabled services or functionality related to a computing device 105. In some embodiments, examples of operating systems 203 may include: Microsoft™ WINDOWS™, Apple™ Mac™ OS/X™, iOS™ operating systems, a Linux operating system, or a Google™ ANDROID™ operating system. Operating systems 203 comprise a system software that manages computer hardware and software resources and provides common services for computer programs.

In some embodiments, examples of input devices 204 may include: a keyboard, a touchscreen, a microphone, a mouse, a touchpad, or a trackball. Input devices 204 comprises a device of any type suitable for receiving user input.

In some embodiments, examples of memory 205 may include: a read-only memory (ROM), read-only memory (ROM) devices, a memristor memory, a random-access memory (RAM), or RAM hardware modules. The memory 205 comprises a mechanism designed to store program instructions, state information, and the like for performing various operations described herein, and may be storage devices 207, in some embodiments.

In some embodiments, examples of output devices 206 may include: screens for visual output, a speaker, or a printer. The output devices 206 comprise devices of any type suitable for outputting computing device 105 related information.

In some embodiments, examples of storage devices 207 may include: a magnetic media, hard disks, floppy disks, a magnetic tape, an optical media, CD-ROM disks, a magneto-optical media, optical disks, a flash memory, solid state drives (SSD), hybrid SSD storage drives, swappable flash memory modules, thumb drives, removable optical storage discs, or an electrical storage device. The storage devices 207 comprises a mechanism designed to store information which in some embodiments may be memory 205.

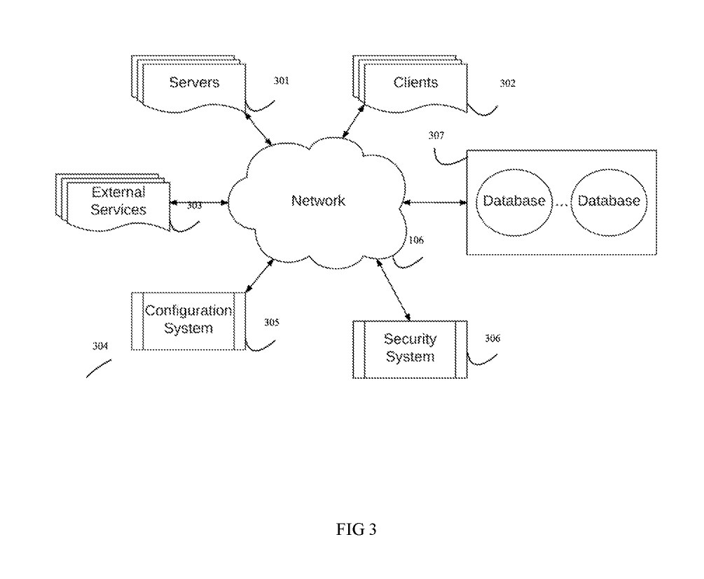

Referring now to FIG. 3, which shows diagram of an exemplary architectural arrangement of clients, servers, and external services according to an embodiment of the invention.

The server 301 comprises a computing device 105 configured to handle requests received from one or more client 302 over a Communications Network.

The client 302 comprises one or more computing device 105 with program instructions for implementing client-side portions of the present system which, in some embodiments, may be connected to a Communications Network.

The external service 303 comprises a web-enabled services or functionality related to or installed on a computing device 105 itself which may be deployed on one or more of a particular enterprises or users premises.

The distributed computing network 304 comprises any number of Clients and/or Servers operably connected to a Communications Network for the purposes of implementing the system.

The configuration system 305 comprises a system common to information technology (IT) and web functions that implement configurations or management systems.

The security system 306 comprises a system common to information technology (IT) and web functions that implements security related functions for the system.

In some embodiments, examples of database 307 may include: a relational database system, a NoSQL system, a Hadoop™ system, a Cassandra system, a Google BigTable, column-oriented databases, in-memory databases, or clustered databases. The database 307 comprises an organized collection of data within program instructions related system, designed to allow the definition, creation, querying, update, and administration of databases.

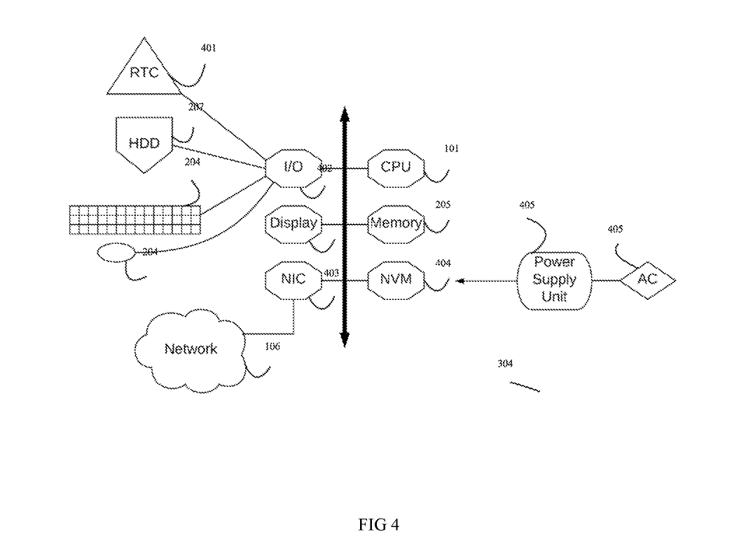

Referring now to FIG. 4, which shows a diagram view of an embodiment of a hardware architecture of a computing device used in various embodiments of the invention.

The real time clock 401 comprises a computing device 105 clock (most often in the form of an integrated circuit) that keeps track of the current time. The input output units 402 comprises devices used by a human (or other system) to communicate with a computer. The NIC 403 comprises a computer hardware component that connects a computer to a computer network. The non-volatile memory 404 comprises a computer memory that can retrieve stored information even after having been power cycled (turned off and back on). The power supply 405 comprises an electronic device that supplies electric energy to an electrical load.

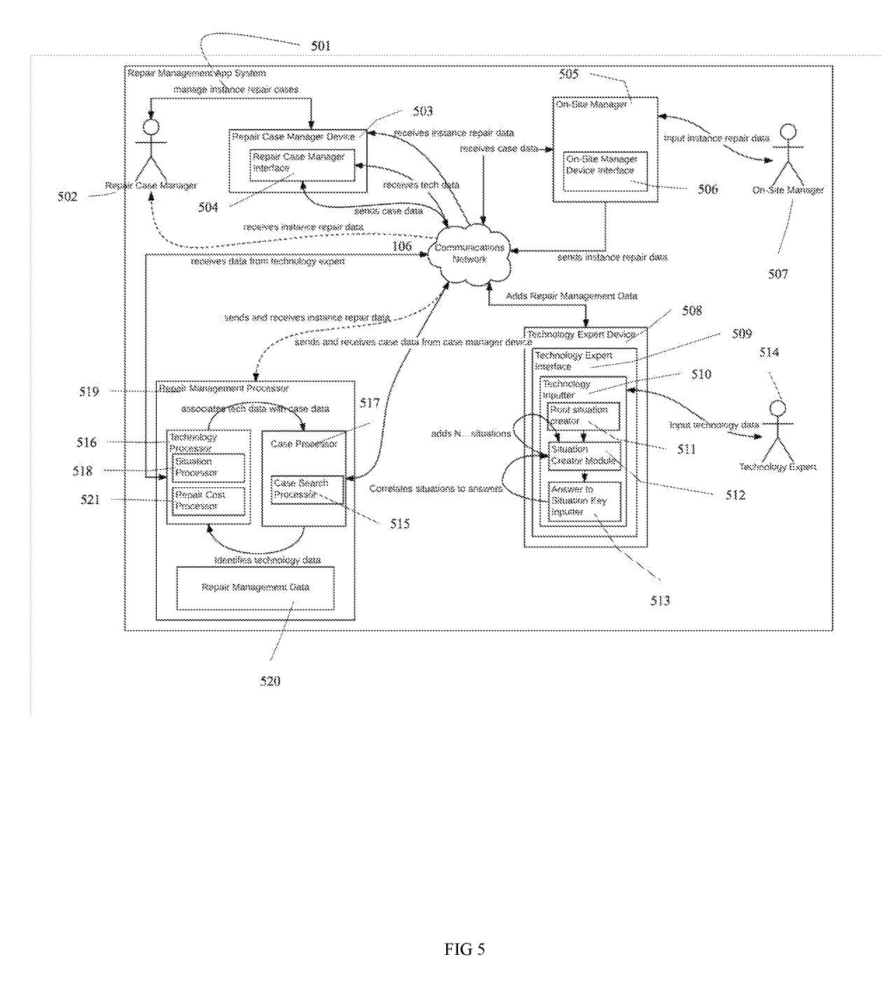

Referring now to FIG. 5, which shows a system diagram of the repair management system.

The repair management app system 501 comprises a system that allows for interaction between one or more technology expert 514, repair case manager 502, and/or on-site manager 507 and permits them to input and interact with repair management data 520 and allows them to perform repairs in a remote location. The repair management app system 501 preferably comprises a repair case manager device 503, an on-site manager device 505, a technology expert device 508, repair management processor 519, and finally, repair management data 520.

The repair case manager 502 is a person who has been tasked with the maintenance of multiple on-site manager 507 in dealing with repair management data 520 via the repair management app system 501.

The repair case manager device 503 comprises a computing device 105 specifically configured for use by a repair case manager 502 in order to work with the on-site manager 507 to perform a repair. The repair case manager device 503 comprises repair case manager interface 504 and external resources interface 708. The repair case manager interface 504 comprises a graphical user interface which is configured for use by the repair case manager 502. The repair case manager interface 504 preferably comprises a case evaluator 702 and finally, a case creator 701. The on-site manager device 505 comprises a computing device 105 which is specifically configured for use by an on-site manager 507. In some embodiments, if the on-site manager device 505 is absent, then the on-site manager 507 interacts with the repair management app system 501 via a nonspecific computing device 105. The on-site manager device 505 comprises an on-site manger device interface 506 and a GPS inputter 801.

The on-site manger device interface 506 comprises a graphical user interface which accepts instance repair data and is configured for use by an on-site manager 507. In some embodiments, if the on-site manger device interface 506 is absent, then the on-site manager 507 could call the repair case manager 502. One goal of the on-site manger device interface 506 is to allows the on-site manager 507 to interact with the repair management app system 501.

The on-site manger device interface 506 has an alternative embodiment herein termed “technology data is sent to the device”. The “technology data is sent to the device” comprises a version where the Repair Case Manager sends the Instance Repair Data and it is opened on a specific computing device.

The on-site manger device interface 506 preferably comprises an on-site manager case evaluator 802. In some embodiments, examples of an on-site manager 507 may include: a local case worker, a user of the technology data 901, or a local repairperson. The on-site manager 507 comprises a person who lives close to technology data 901. The technology expert device 508 comprises a computing device 105 that is configured for use by a technology expert 514.

In some embodiments, if the technology expert device 508 is absent then a technology expert 514 can access the repair management app system 501 via another computing device 105. One goal of the technology expert device 508 is inputting and configuring technology data 901 for use by one or more repair case manager 502 and on-site manager 507. The technology expert device 508 preferably comprises a technology expert interface 509.

The technology expert interface 509 comprises a graphical user interface that is configured for use by a technology expert 514. The technology expert interface 509 preferably comprises a technology inputter 510.

The technology inputter 510 comprises a graphical user interface which permits a technology expert 514 to simultaneously interact with and input technology data 901 into the repair management app system 501. One goal of the technology inputter 510 is to enable a technology expert device 508 to input and interact with technology data 901. The technology inputter 510 preferably comprises a root situation creator 511, a situation creator module 512, and finally, an answer to situation key inputter 601.

The root situation creator 511 comprises a graphical user interface which permits a technology expert 514 to simultaneously interact with and input root situation data 902 into the repair management app system 501. One goal of the root situation creator 511 is to allow for the input of root situation data 902 into the repair management app system 501 by a technology expert device 508.

The situation creator module 512 comprises a graphical user interface which permits a technology expert 514 to interact with and input situation data 904 into the repair management app system 501. One goal of the situation creator module 512 is to enable a technology expert device 508 to input and interact with situation data 904. The situation creator module 512 comprises an answers inputter 602 and evaluation inputter 604.

The answer to situation key data 513 comprises data or data objects which store information about the next step in the process. In some embodiments, examples of answer to situation key data 513 may include: an information request, an external resource, or a solution.

The technology expert 514 comprises a person with specialized knowledge in the repair and maintenance of one or more technology data 901. The case search processor 515 comprises a means to enable a person to perform a search on case data 911 for historical cases based on technology, location, etc. One goal of the case search processor 515 is to enable the repair management processor 519 to perform a search on case data 911.

The technology processor 516 comprises a technology processor 516 which accepts technology data 901 and identifies the next situation data 904 based on the answer to situation key data 513 as configured to the chosen answers data 908. One goal of the technology processor 516 is to enable the ability of the system to process technology data 901 to determine the next situation data 904 based from previous answers data 908.

The technology processor 516 comprises a situation processor 518 and a repair cost processor 521. The case processor 517 sends and receives case data 911 from the repair case manager device 503 and sends the case data 911 to the repair management processor 519. The case processor 517 preferably comprises case search processor 515.

The situation processor 518 comprises an accepts situation data 904 and identifies any risk factor data 909, asynchronous information request data 907, answers data 908, or monetary value data 910 associated with an instance of situation data 904. One goal of the situation processor 518 is to processes situation data 904 related functions and accept asynchronous input.

The repair management processor 519 comprises and accepts repair management data 520 and associates technology data 901 with case data 911. The repair management processor 519 comprises a technology processor 516 and case processor 517.

The repair management data 520 comprises data or data objects which store information within the repair management app system 501. The repair management data 520 comprises case data 911 and technology data 901.

The repair cost processor 521 comprises a module which analyses technology data 901 to determine the range of highest to lowest monetary value data 910 based on the current situation data 904 and the possible child situation data 904. One goal of the repair cost processor 521 is to enables the repair management app system 501 to calculate a range of possible Repair costs.

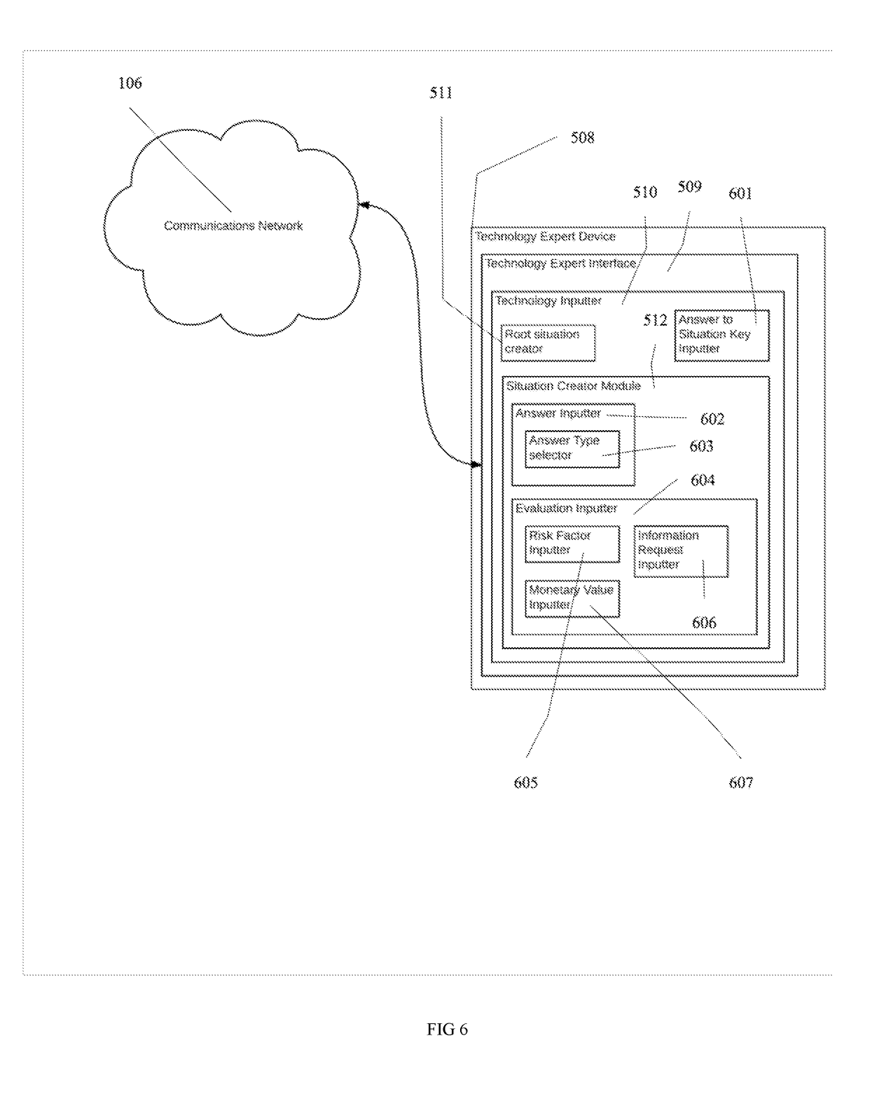

Referring now to FIG. 6, which shows a diagram of technology expert devices and input interfaces.

The answer to situation key inputter 601 comprises a graphical user interface which permits a technology expert device 508 to interact with and input technology data 901 into the repair management app system 501. One goal of the answer to situation key inputter 601 is to enable a technology expert device 508 to interact with and input answer to situation key data 513.

The answers inputter 602 comprises a graphical user interface which permits a technology expert 514 to interact with and input answers data 908 into the repair management app system 501. One goal of the answers inputter 602 is to allow for the input of answers data 908 into the repair management app system 501. The answers inputter 602 preferably comprises an answer type selector 603.

The answer type selector 603 comprises a graphical user interface which permits a technology expert 514 to interact with and input the type of answers data 908 into the repair management app system 501. One goal of the answer type selector 603 is to allow for the selection and configuration of the input type of an answer to situation key data 513.

The evaluation inputter 604 comprises a graphical user interface which allows for the input of evaluation data. The evaluation inputter 604 preferably comprises a monetary value inputter 607, information request inputter 606, and finally a risk factor inputter 605.

The risk factor inputter 605 comprises a graphical user interface which permits a technology expert 514 to interact with and input risk factor data 909 into the repair management app system 501. One goal of the risk factor inputter 605 is to allow for the input of risk factor data 909 by a technology expert device 508 into the repair management app system 501.

The information request inputter 606 comprises a graphical user interface which permits a technology expert 514 to interact with and input asynchronous information request data 907 into the repair management app system 501. One goal of the information request inputter 606 is to enable a technology expert device 508 to input and interact with asynchronous information request data 907.

The monetary value inputter 607 comprises a graphical user interface which permits a technology expert 514 to interact with and input monetary value data 910 into the repair management app system 501. One goal of the monetary value inputter 607 is to allow the repair management app system 501 to calculate the total repair cost of a broken piece of technology.

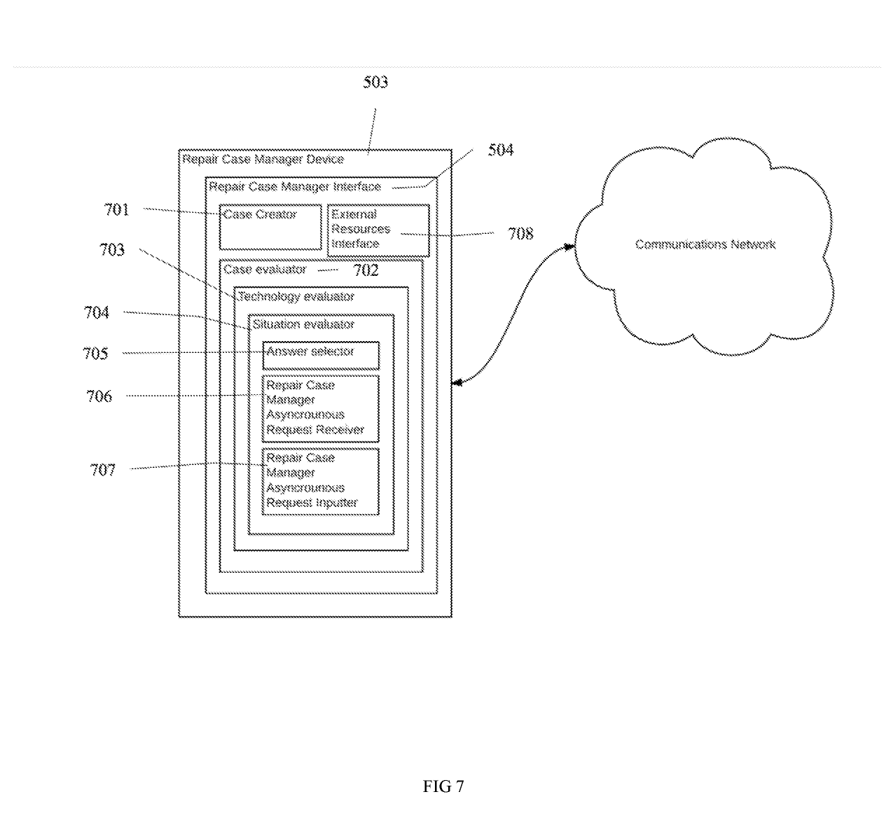

Referring now to FIG. 7, which shows a diagram of the organization of a repair case manager device and interfaces.

The case creator 701 comprises a graphical user interface which allows a repair case manager 502 to input case data 911 into the repair management app system 501. One goal of the case creator 701 is to enable a repair case manager 502 to create and manage case data 911.

The case evaluator 702 comprises a module which allows a repair case manager device 503 to send and receive case data 911 to the case processor 517 via a communications network 106. One goal of the case evaluator 702 is to enable the repair case manager 502 to interact with case data 911 within the repair management app system 501 via the case processor 517 and to send and receive case data 911 to an on-site manager device 505 via a communications network 106.

The case evaluator 702 preferably comprises a technology evaluator 703 and finally, GPS location. The technology evaluator 703 comprises a module which allows a repair case manager device 503 to send and receive technology data 901 to the technology processor 516 via a communications network 106. One goal of the technology evaluator 703 is to enable the repair case manager 502 to interact with technology data 901. The technology evaluator 703 preferably comprises a situation evaluator 704.

The situation evaluator 704 comprises a module which allows a repair case manager device 503 to send and receive situation data 904 to the situation processor 518. One goal of the situation evaluator 704 is to enable a repair case manager 502 to interact with situation data 904. The situation evaluator 704 preferably comprises an answer selector 705, a repair case manager asynchronous request receiver 706, and finally, a repair case manager asynchronous request inputter 707.

The answer selector 705 comprises a graphical user interface which is configured to allow a repair case manager 502 to interact with the answers data 908. One goal of the answer selector 705 is to enable the repair case manager 502 to interact with answers data 908.

The repair case manager asynchronous request receiver 706 comprises a graphical user interface for accepting input from an on-site manager 507 during troubleshooting on a per situation basis. The repair case manager asynchronous request inputter 707 comprises a graphical user interface for transmitting asynchronous information request data 907 to an on-site manager 507 about a particular repair situation.

The external resources interface 708 comprises a graphical user interface which accepts resources available data 905 into the repair management app system 501. One goal of the external resources interface 708 is to enable the repair case manager 502 to interact with and input the resources available data 905 into the repair management app system 501.

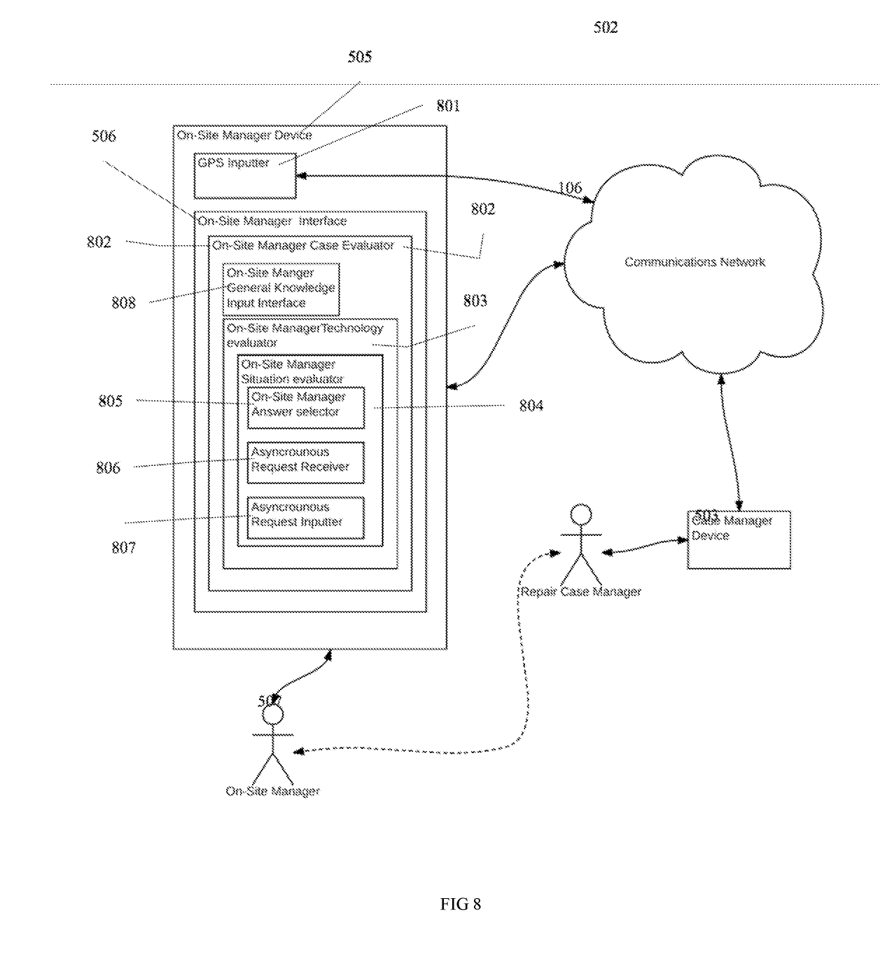

Referring now to FIG. 8, which shows a diagram of the interaction between on-site manager devices, repair case member devices and persons.

The GPS inputter 801 comprises a graphical user interface that allows a repair case manager 502 to designate their GPS coordinates as the same as a person of skilled labor. The on-site manager case evaluator 802 comprises a graphical user interface which permits an on-site manager 507 to send and receive case data 911 to the case processor 517. One goal of the on-site manager case evaluator 802 is to allow the on-site manager 507 to interact with case data 911. The on-site manager case evaluator 802 comprises an on-site manager technology evaluator 803 and on-site manger general knowledge input interface 808.

The on-site manager technology evaluator 803 comprises a module which allows an on-site manager device 505 to send and receive technology data 901 to the technology processor 516. One goal of the on-site manager technology evaluator 803 is to enable the on-site manager 507 to interact with technology data 901. The on-site manager technology evaluator 803 preferably comprises an on-site manager situation evaluator 804.

The on-site manager situation evaluator 804 comprises a module which allows an on-site manager device 505 to send and receive situation data 904 to the situation processor 518. One goal of the on-site manager situation evaluator 804 is to enable the on-site manager 507 to interact with situation data 904.

The on-site manager situation evaluator 804 preferably comprises an on-site manager answer selector 805, asynchronous request inputter 807, and finally asynchronous request inputter 707. The on-site manager answer selector 805 comprises a graphical user interface which is configured to allow an on-site manager 507 to interact with the answers data 908. One goal of the on-site manager answer selector 805 is to enable the on-site manager 507 to interact with answers data 908. The asynchronous request inputter 707 comprises a graphical user interface for accepting input from a repair case manager 502 during trouble shooting on a per situation basis.

The asynchronous request inputter 707 comprises a graphical user interface for transmitting asynchronous information request data 907 to a repair case manager 502 about a particular repair situation. The on-site manger general knowledge input interface 808 comprises a graphical user interface that allows an on-site manager 507 to indicate that a technology or situation data 904 needs to be repaired that is not in the repair management app system 501, or that more help is needed from a repair case manager 502. The on-site manger general knowledge input interface 808 functions to both (1) allow an on-site manager 507 to input general input knowledge data 906 into the repair management app system 501 and to (2) enable the on-site manager 507 to open communication with a repair case manager 502 to indicate that more help is needed.

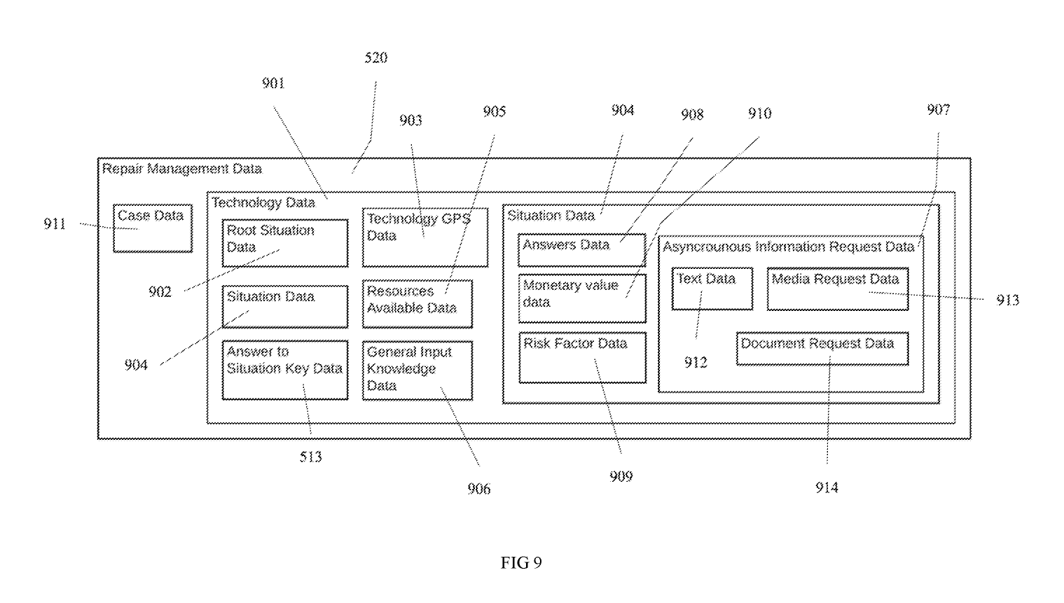

Referring now to FIG. 9, which shows a diagram of the organization of repair management data. Technology data 901 comprises a piece of equipment or service that has troubleshooting data input into the repair management data 520. The technology data 901 has multiple alternative embodiments herein termed a “gravity fed spring system” embodiment, a “rain water catchment system” embodiment, and a “water well” embodiment.

The technology data 901 preferably comprises root situation data 902, resources available data 905, technology GPS data 903, general input knowledge data 906, situation data 904, and finally, answer to situation key data 513. The root situation data 902 comprises the first situation data 904 that is stored in the technology data 901 and by definition, does not have an answer to situation key data 513 that is linked to it.

The technology GPS data 903 comprises data or data objects which store location data for technology data 901. One goal of the technology GPS data 903 is to allow the repair management app system 501 to geolocate resources available data 905.

The situation data 904 comprises data or data objects which store information about a particular step in the repair of a technology data 901. In some embodiments, an example of the situation data 904 could be a contact request or perhaps general knowledge input and the like. The situation data 904 preferably comprises asynchronous information request data 907, answers data 908, monetary value data 910, and finally, risk factor data 909.

The resources available data 905 comprises data or data objects which store information about what resources are available in the area around the technology data 901. In some embodiments, examples of resources available data 905 may include: equipment, a part, consumables, skilled labor, or local people.

The general input knowledge data 906 comprises data or data objects which store information within the system regarding technology data 901. In some embodiments, examples of general input knowledge data 906 may include: the on-site manager 507 does not know what the technology is, the on-site manager 507 may need a domain expert, a manual, a picture, or a last maintenance date.

The asynchronous information request data 907 comprises data or data objects which store information indicating that additional information is needed in order to continue to navigate the technology data 901. One goal of the asynchronous information request data 907 is to serve as contact point between a repair case manager 502 and an on-site manager 507.

The asynchronous information request data 907 preferably comprises media request data 913, document request data 914, and finally, text data 912. The answers data 908 comprises data or data objects which indicates the type of response which can be given by the user for specific situation data 904. In some embodiments, examples of answers data 908 may include: a radio box, a checkbox, a text input, an answer of true/false, or a scale.

The risk factor data 909 comprises data or data objects which store information regarding the risk of a particular answer to situation key data 513 and/or risk of a particular situation data 904. One goal of the risk factor data 909 is to enable the repair management app system 501 to calculate the risk of completing and executing one or more answers to situation key data 513.

The monetary value data 910 comprises data or data objects which store cost information regarding the situation data 904. One goal of the monetary value data 910 is to allow the repair management app system 501 to compute a detailed estimate of repairs.

The case data 911 comprises data or data objects which store information regarding one or more instances of repair that is needed as related to technology data 901 within the repair management app system 501. In some embodiments, examples of case data 911 may include: location data, time data, equipment data, user data, or expenses. The text data 912 comprises data or data objects which store information relating to additional text inputs which are needed or may be useful to navigate technology data 901.

The media request data 913 comprises data or data objects which store information relating to additional media files which are needed or may be useful in assisting with navigating technology data 901. In some embodiments, an example of the media request data 913 could be an image or perhaps a video and the like.

The document request data 914 comprises data or data objects which store information relating to additional documents which are needed in order to navigate technology data 901. In some embodiments, examples of document request data 914 may include: permits, invoices, receipts, or contracts.

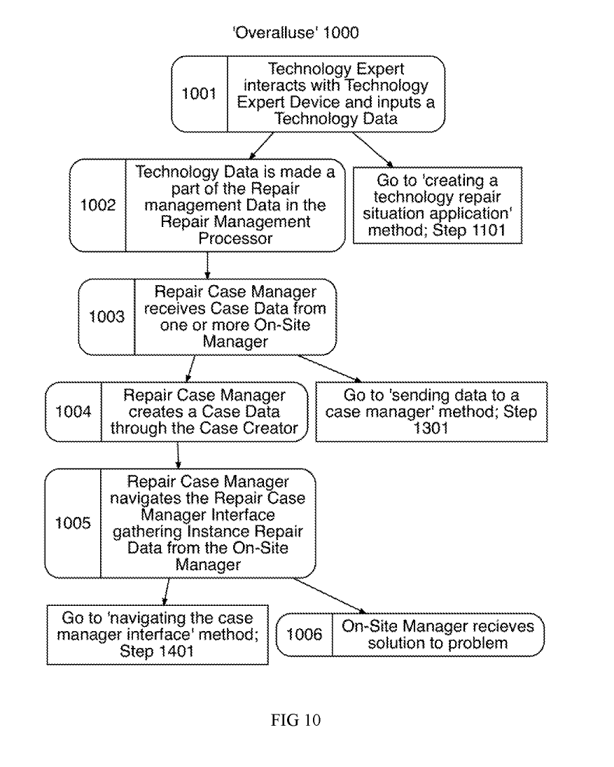

Referring now to FIG. 10, which shows the overall use of the system.

In a first step, a technology expert 514 interacts with a technology expert device 508 and inputs an instance of technology data 901 (Step 1001). Step 1001 is further detailed below in a related method (1100—‘creating a technology repair situation application’). Next, technology data 901 is made a part of the repair management data 520 in the repair management processor 519 (Step 1002). Next, a repair case manager 502 receives case data 911 from one or more on-site manager 507 (Step 1003). Step 1003 is further detailed below in a related method (1300—‘sending data to a case manager’). Next, a repair case manager 502 creates case data 911 through the case creator 701 (Step 1004). Next, a repair case manager 502 navigates the repair case manager interface 504 gathering instance repair data from the on-site manager 507 (Step 1005). Step 1005 is further detailed below in a related method (1400—‘navigating the case manager interface’). Next, an on-site manager 507 receives a solution to problem (Step 1006).

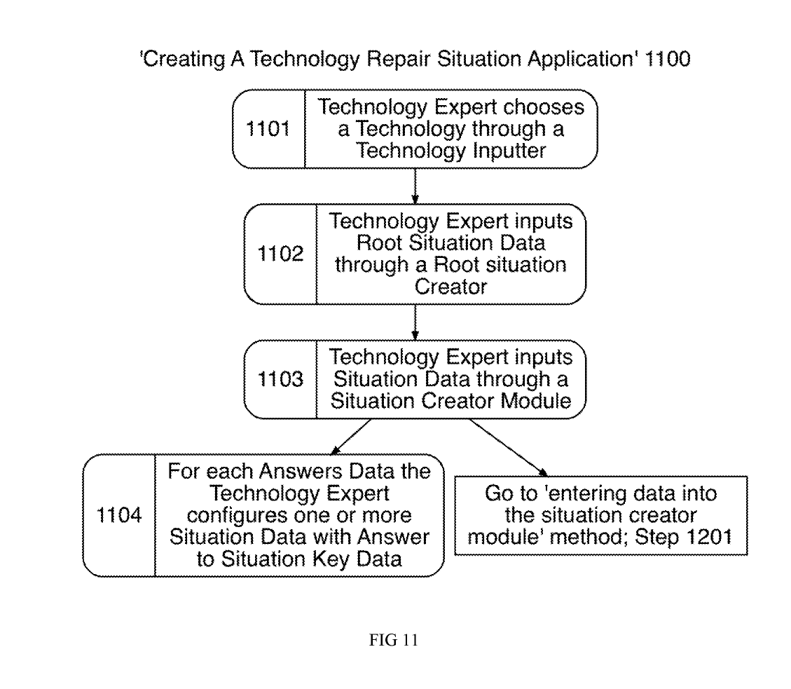

Referring now to FIG. 11, which shows a diagram of creating a technology repair situation application.

In a first step, a technology expert 514 chooses a technology through a technology inputter 510 (Step 1101). Next, technology expert 514 inputs root situation data 902 through a root situation creator 511 (Step 1102). Next, technology expert 514 inputs situation data 904 through a situation creator module 512 (Step 1103). Step 1103 is further detailed below in a related method (1200—‘entering data into the situation creator module’). Next, for each answers data 908, the technology expert 514 configures one or more situation data 904 with answer to situation key data 513 (Step 1104). In some embodiments, the information collected by method 1100 comprises a technical repair profile.

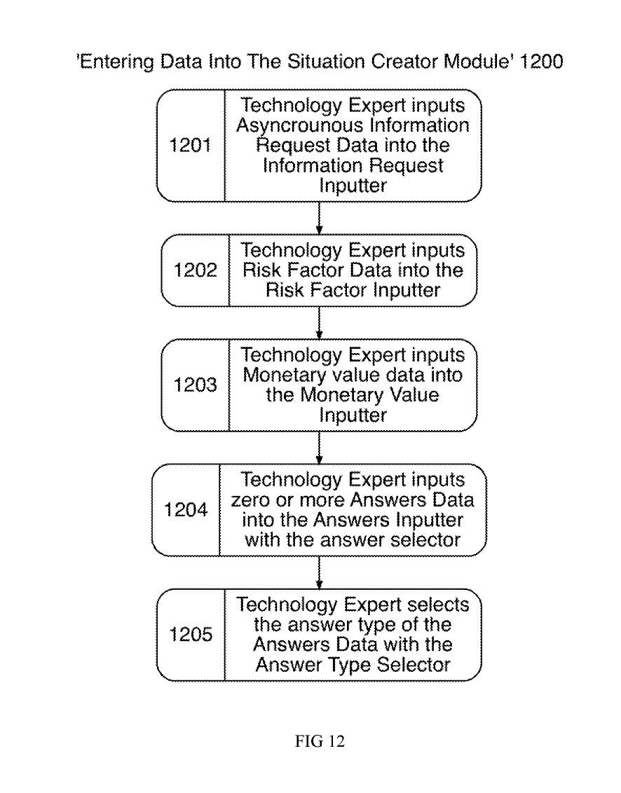

Referring now to FIG. 12, which shows entering data into the situation creator module.

In a first step, a technology expert 514 inputs asynchronous information request data 907 into the information request inputter 606 (Step 1201). Next, technology expert 514 inputs risk factor data 909 into the risk factor inputter 605 (Step 1202). Next, a technology expert 514 inputs monetary value data 910 into the monetary value inputter 607 (Step 1203). Next, a technology expert 514 inputs zero or more answers data 908 into the answers inputter 602 with the answer selector 705 (Step 1204). Next, a technology expert 514 selects the answer type of the answers data 908 with the answer type selector 603 (Step 1205).

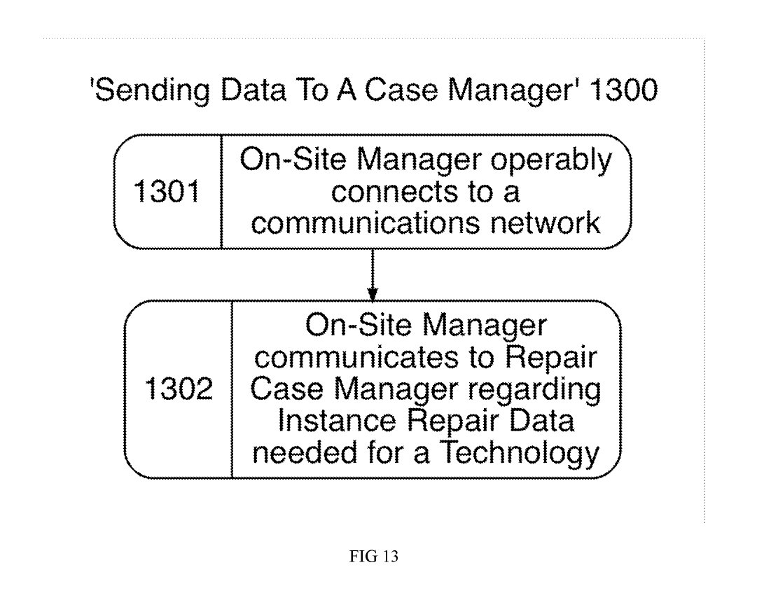

Referring now to FIG. 13, which shows sending data to a case manager.

In a first step, an on-site manager 507 operably connects to a communications network 106 (Step 1301). Next, an on-site manager 507 communicates to repair case manager 502 regarding an instance of repair data needed for a technology (Step 1302).

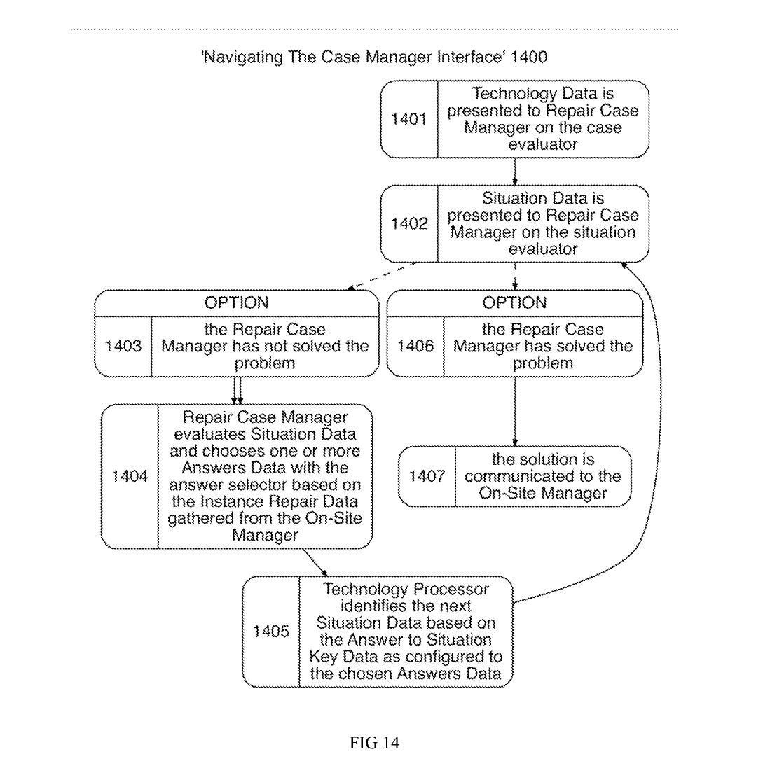

Referring now to FIG. 14, which shows navigating the case manager interface.

In a first step, technology data 901 is presented to a repair case manager 502 on the case evaluator 702 (Step 1401). Next, situation data 904 is presented to a repair case manager 502 on the situation evaluator 704 (Step 1402). If the repair case manager 502 has not solved the problem (Step 1403), then the repair case manager 502 evaluates situation data 904 and chooses one or more answers data 908 with the answer selector 705 based on the instance repair data gathered from the on-site manager 507 (Step 1404). Next, the technology processor 516 identifies the next situation data 904 based on the answer to situation key data 513 as configured to the chosen answers data 908 (Step 1405). Next, refer to Step 1402. From Step 1402, if the repair case manager 502 has solved the problem (Step 1406), then the solution is communicated to the on-site manager 507 (Step 1407).

The following elements: a gravity fed spring system, rain water catchment system, water well, GPS location, and technology data is sent to the device, are important for the working functionality, but do not appear in the drawings and are shown below.

The GPS location comprises data or data objects which store location information of the Repair Case Manager for use by the repair management app system 501. One goal of the GPS location is to allow the repair management app system 501 to calibrate the services available to the Community Manager.

The skilled person will be aware of a range of possible modifications of the various embodiments described above. Accordingly, the present invention is defined by the claims and their equivalents.

What is claimed is:

1. A repair management system comprising:
a network-connected repair management server comprising a memory and a processor and further comprising programmable instructions stored in the memory and operating on the processor, the instructions when executed by the processor, cause the processor to:
receive a plurality of connection from a plurality of user devices over a network;
receive a technical repair profile from a first user device;
receive case data from one or more case manager devices;
receive instance repair data from the on-site manager.
